(19) United States
(12) Patent Application Publication
(10) Pub. No.: US 2017/0254499 A1
(43) Pub. Date: Sep. 7, 2017

(54) SUBSTRATE FOR A LIGHT MODULE WITH METAL STRIP USED AS SHIELDING, A HEAT SCREEN AND/OR AN OPTICAL REFLECTOR

(71) Applicant: Valeo Vision, Bobigny Cedex (FR)

(72) Inventors: Hui Jin, Paris (FR); Zdravko Zojceski, Courbevoie (FR); Christophe Dubosc, Villemomble (FR); David Hue, Butry Sur Oise (FR)

(21) Appl. No.: 15/508,547

(22) PCT Filed: Sep. 7, 2015
(86) PCT No.: PCT/EP2015/070338

§ 371 Date: Mar. 3, 2017

(30) Foreign Application Priority Data
Sep. 15, 2014 (FR) 1458671

(51) Int. Cl. F21S 8/10; B60Q 1/34; B60Q 1/30; B60Q 1/44

(52) U.S. Cl. CPC F21S 48/217; F21S 48/238; F21S 48/31; B60Q 1/44; B60Q 1/34; F21S 48/2212; F21S 48/328; B60Q 1/30; F21Y 2115/15

(57) ABSTRACT

A light module, particularly for a motor vehicle, comprising a substrate, one or more light sources arranged on the substrate, and a metal coating on the substrate, forming power supply strips for the light source or sources. The metal coating extends at a distance from the supply strips and/or transversely with respect to said strips, in such a way as to form one or more auxiliary zones providing a heat screen, reflective surface, aesthetic surface, and/or electromagnetic shielding function.

The invention relates to the field of lighting and/or light signaling, particularly for a motor vehicle. More precisely, the invention relates to the field of lighting and of light signaling by means of light-emitting diodes (LEDs), and more particularly organic light-emitting diodes (OLEDs).

The published patent document FR 2 995 657 A1 discloses a light source with OLED diodes, comprising a supporting means with cavities filled by the diodes. The supporting means comprises, on one of the faces thereof, electrodes or electric strips intended to be in electrical contact with the diodes in order to provide them with power. The diodes comprise a stack of organic layers and a transparent substrate arranged on the stack in question. The substrate has a surface with a size greater than that of the organic layers in order to extend beyond the corresponding cavity and thus come into contact with the electric strips, in the area around the cavity. The supporting means is produced by injection of insulating material such as thermoplastic or thermosetting plastic. It can be planar, with a projection or with a more complex shape. The electric strips are restricted to powering the diodes. The function provided by the light source of this teaching is restricted to the specific function thereof. An optical system is indeed necessary to produce a light module.

The patent document US 2005/0243558 A1 discloses a supporting means for LED diodes for a motor vehicle rear light signaling module. It is made up of a plate with a printed circuit and comprising a series of openings through which are inserted reverse-mount LED diodes. These LEDs comprise dome-shaped optical parts, these domes being visible on the front face side. The LEDs comprise fixing and electrical connection tabs soldered with electric strips on the rear face of the plate. This mounting provides an aesthetic supporting means when it is observed from a viewpoint located on the front face side, the electrical connections being exclusively on the rear face. Moreover, it allows a heat sink to be placed on the rear face of the LED base. Similar to the two teachings above, the LED supporting means disclosed in this teaching is advantageous for planar mountings. It is less advantageous however for signaling modules having a complex shape. Moreover, similar to the previous teaching, the function provided by the light source is restricted to the specific function thereof in that an optical system is necessary to produce a light module.

The aim of the invention is to propose an optimized light construction module particularly from the point of view of integrating the light source or sources.

The object of the invention is a lighting and/or light signaling module, particularly for a motor vehicle, comprising: a substrate; one or more light sources arranged on the substrate; a set of metal strips arranged on the substrate, the set forming at least one power supply zone for the light source or sources; characterized in that some of the set of metal strips extend at a distance from the supply zone or from at least one of the supply zones and/or transversely with respect to said zone or to at least one of said zones, in such a way as to form one or more auxiliary zones separate from a power supply function, for example a heat screen, reflective surface, aesthetic surface, and/or electrical or magnetic shielding function.

In other words, the auxiliary zone or zones do not have any influence with respect to the power supply of the light source or sources.

The concept of an auxiliary zone providing a heat screen function means an auxiliary zone allowing the conduction and the dissipation of the heat.

According to an advantageous embodiment of the invention, the auxiliary zone or zones are not coplanar with the zone or zones of the substrate supporting the light source or sources.

According to an advantageous embodiment of the invention, the auxiliary zone or at least one of the auxiliary zones is connected to a supply strip for the light source or for at least one of the light sources, said strip being intended to be connected to the ground, said auxiliary zone or zones providing an electrical shielding function.

The auxiliary zones can comprise copper, over a copper thickness of 2 μm minimum, or from 5 to 15 μm.

Advantageously, the set of strips forms several auxiliary zones, these auxiliary zones extending with respect to one another in a non-coplanar manner. The auxiliary zones thus form a Faraday cage in order to complete the electrical shielding function.

According to an advantageous embodiment of the invention, the metal coating of the auxiliary zone or zones comprises nickel, said auxiliary zone or zones providing a magnetic shielding function. In this case, it is possible to provide a nickel thickness of a minimum of 2 μm, or from 5 to 10 μm.

According to an advantageous embodiment of the invention, the light source or at least one of the light sources is of the organic light-emitting diode type projecting from the substrate.

According to an advantageous embodiment of the invention, the substrate comprises a cavity with a bottom and at least one side wall, the auxiliary zone or at least one of the auxiliary zones extending over the side wall or walls, providing a heat screen, reflective surface and/or aesthetic surface function. The light source or at least one of the light sources can be arranged on the bottom of the cavity. The strips of the auxiliary zone can include a copper layer arranged such that the auxiliary zone provides a heat screen function. For example, the copper layer can have a thickness of 15-30 μm micrometers.

According to an advantageous embodiment of the invention, the metal coating of the heat shield, reflective surface and/or aesthetic surface auxiliary zone or zones comprises copper, silver and/or gold. The strips of the auxiliary zone can include a gold or silver layer arranged such that the auxiliary zone provides a reflective surface function. For example, the gold layer can have a thickness of 50 nm such as to provide a reflectivity of at least 50%.

According to an advantageous embodiment of the invention, the cavity is generally elongated in a main direction, several of the light sources being arranged on the bottom of the cavity in the main direction.

According to an advantageous embodiment of the invention, the light sources are electrically connected in series by the power supply strips extending in the main direction of the cavity, the auxiliary zones extending from said strips, laterally on both sides of the main direction.

According to an advantageous embodiment of the invention, the cavity accommodates an optical device; said device, the light sources accommodated at the bottom of the cavity and the auxiliary zones extending over the lateral wall or walls forming a signaling light beam.

According to an advantageous embodiment of the invention, the substrate comprises at least one front wall projecting from the side wall or from one of the side walls of the cavity, the shielding auxiliary zone or at least one of the shielding auxiliary zones being arranged on the front wall or one of the front walls.

According to an advantageous embodiment of the invention, the auxiliary zone or each of the auxiliary zones has an average width of more than 3 mm, preferably more than 5 mm.

According to an advantageous embodiment of the invention, the metal coating comprises nickel, gold, silver and/or copper.

According to an advantageous embodiment of the invention, the substrate is a rigid molded piece having a three-dimensional shape. Advantageously, the substrate is mainly made up of a wall with an average thickness of between 0.5 and 3 mm.

According to an advantageous embodiment of the invention, the substrate is made from a thermoplastic material doped with metal particles such as to allow the bonding of the metal coating.

According to an advantageous embodiment of the invention, the light source or at least one of the light sources is connected to the power supply strips by an adhesive loaded with metal particles, said adhesive being preferentially a polymer adhesive suitable for polymerizing after application.

According to an advantageous embodiment of the invention, the module is suitable for forming at least one light beam along an optical axis towards the front of the module, the auxiliary zones of the metal coating being arranged on a face of the substrate which is directed towards the front of said module.

The invention also relates to a light device, particularly for a motor vehicle, comprising: a housing; at least one light module suitable for forming at least one light beam; characterized in that the light module or at least one of the light modules is in accordance with the invention.

The measures of the invention are advantageous in that they make it possible to produce, with the metal coating, electric strips having other functions like electromagnetic shielding, heat screen, reflective and/or aesthetic surface functions. This is all the more advantageous when the substrate is molded using the MID (Molded Interconnect Device) technology since the substrate can then become a visible piece providing, in addition to a function for supporting the light sources, functions for a support on which are mounted optical elements of the module. The level of integration of functions into the substrate is then particularly high. These measures also offer an economical advantage since the operations of depositing the metal coating of the electric strips and of the auxiliary zones are carried out at the same time.

Other features and advantages of the present invention will be better understood from the description and the drawings wherein:

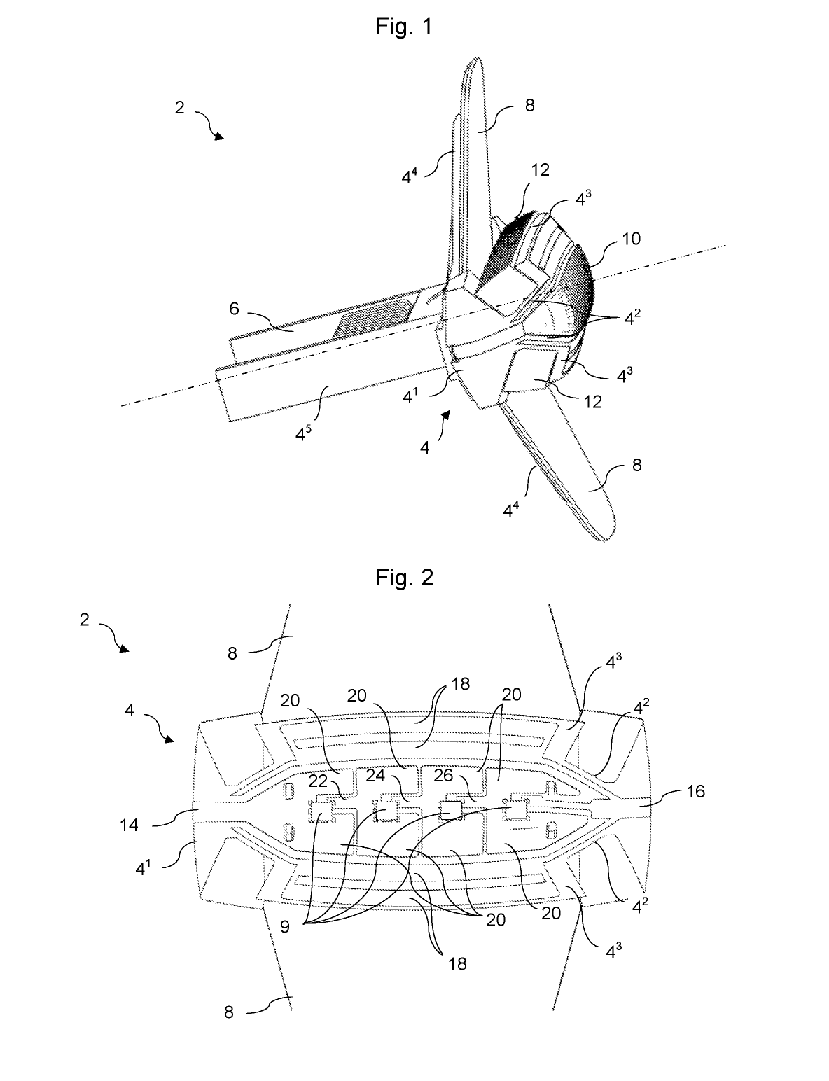

FIG. 1 is a perspective view of a light module in accordance with the invention;

FIG. 2 is a front view of the module of FIG. 1, however without the central collimator;

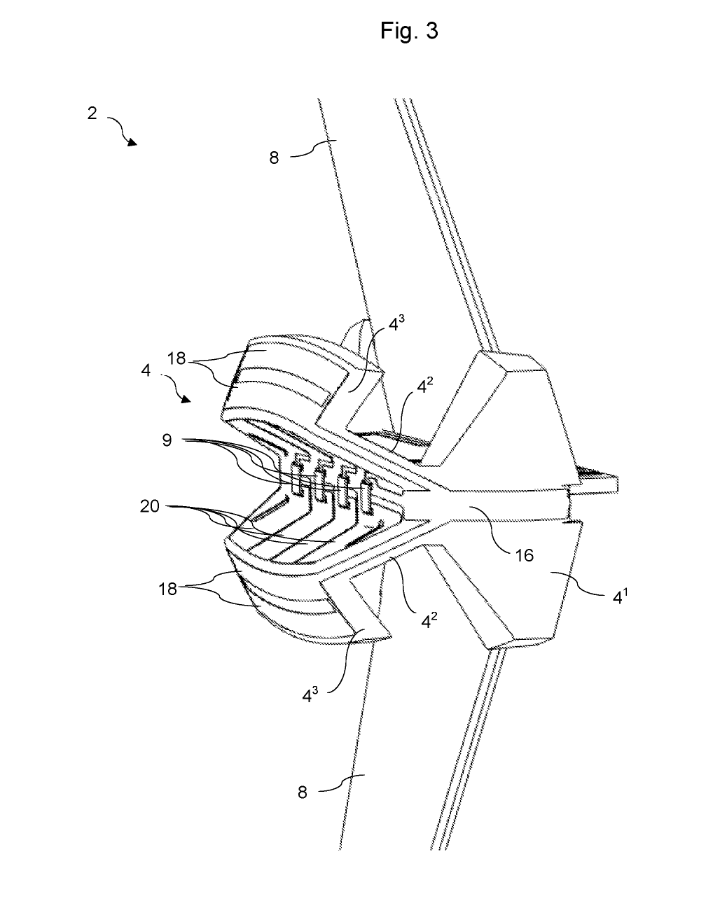

FIG. 3 is a perspective and side view of the module of FIGS. 1 and 2.

FIG. 1 illustrates a motor vehicle light signaling module. The module 2 is configured to be accommodated in a housing arranged at the rear of the vehicle. It is configured to provide a lamp (or rear light) function, a stop light function and a direction indicator (or turn signal light) function.

The module 2 comprises a substrate 4 provided with a central part 4¹, two side walls 4², two front walls 4³ projecting from the side walls 4², two supporting means 4⁴ and a rear part 4⁵. The rear part 4⁵ is configured to engage a power supply connector 6. The two side walls 4² form a cavity accommodating light sources (not visible in FIG. 1) and a collimator 10 in order to form a light beam for a direction indicator function. The supporting means 4⁴ are arranged such as to project from the central part 4¹ of the substrate 4 such that they are essentially opposite one another. Each of these supporting means 4⁴ bears an OLED diode 8. An OLED is a light-emitting diode comprising a stack of several organic semiconducting layers between two electrodes, (at least) one of which is transparent. In this case, these OLED diodes provide a lamp function. The substrate 4 of the module also supports one or more light sources (not visible) between the side walls 4² and the OLED diodes 8, this light source or these light sources being covered with a collimator 12 in order to provide a stop light function. More precisely, the rays emitted by these light sources are deflected by the collimator 12 in order to meet the front face of the corresponding OLED diode 8 and be reflected there towards the front of the module.

The longitudinal axis of the module shown in FIG. 1 corresponds to the optical axis thereof. This means that the various light beams produced by the module 2 are mainly orientated along this axis. All of these beams are preferentially directed towards the front of the module (corresponding to the right-hand side of FIG. 1 and to the rear of the vehicle).

The collimators 10 and 12 are pieces made from transparent or translucent material, such as glass or polycarbonate (PC) or Plexiglas (PMMA). They comprise input or output surfaces orientated such as to deflect the rays in a main direction, by applying the Snell-Descartes refraction law. The input and output faces indeed each form a refracting surface, namely a surface separating two homogenous and isotropic transparent media, with different refractive indices. The refractive index of air is indeed approximately 1 whereas the refractive index of glass and of polycarbonate is between 1.4 and 1.6 approximately. The operating principle of a collimator is well known per se by a person skilled in the art; as a result, it is not necessary to describe it in further detail.

The substrate 4 is made from plastic produced by molding and supports the light sources and the electric strips, in accordance with the MID (Molded Interconnect Device) technology.

FIG. 2 illustrates the front face of the module 2 of FIG. 1, the central collimator 10 however being absent. FIG. 3 is a side view of the module without the central collimator 10 and the side collimators 12.

It can be seen that the two side walls 4² of the substrate form a cavity accommodating several LED light sources 9. The latter are spread in the transverse direction corresponding to the main direction of the cavity. These diodes are fixed directly on the substrate 4 preferentially by adhering with an adhesive loaded with metal particles, said adhesive being preferentially a polymer adhesive suitable for polymerizing after application. The use of adhesive is advantageous in that it allows for the prevention of thermal stresses on the substrate.

The diodes 9 are electrically connected with each other in series and powered by the electric strips 14 and 16. In this case, the strip 14 is intended to be brought to a positive potential, such as, for example, +12 volts, whereas the strip 16 is intended to be connected to the ground of the vehicle.

It is interesting to note that the front walls 4³ comprise electric strips 18 directly connected to the ground strip 16. These electric strips provide a function for shielding against external electromagnetic fields. More particularly, they form an electric field with the OLED diodes, which comprise electrodes intended to be connected to a positive potential (+12 volts). This closed field is suitable for protecting the operation of the OLED diode from electromagnetic interference coming from outside or inherent in the operation of the OLED itself. The OLED diodes, as a result of the larger size thereof, are indeed more sensitive to this type of interference and generate some electrical interference which can be damaging thereto. The front walls 4³ of the substrate 4 extending transversely along the OLED diodes are particularly well positioned in order to form a closed electromagnetic field with the OLED diodes and the electric strips 18. The electric strips 18 thus form auxiliary zones providing an electromagnetic shielding function. They also provide an aesthetic function.

It is also interesting to note that the electric strip 14 of positive potential (+12 volts) extends transversely with respect to the main direction thereof (which is transverse, in this case) towards zones 20 covering the inner faces of the side walls 4² forming the cavity. The same applies to the strips 22, 24 and 26 which interconnect the diodes 9 in series. These auxiliary zones 20 are at a positive potential when the diodes 9 are powered. They provide a thermal and/or optical screen function in that they protect the walls 4² of the substrate 4 supporting them from the potentially considerable thermal radiation emitted by the diodes 9. Depending on the material used, these zones can also reflect some of the light radiation incident at the walls supporting them.

The plastic of the substrate can be doped with metal particles suitable for bonding the metal strips 14, 16, 18, 20, 22, 24 and 26 on the outer surface thereof.

The electric strips can be produced by LDS (Laser Direct Structuring) technology. This involves running a laser beam over the corresponding surface of the substrate, according to the configuration of the strips to be produced. The effect of the laser beam is to form roughness suitable for promoting the bonding. This step is followed by a metallization by steeping the substrate in one or more successive metal baths.

Alternatively or additionally, the electric strips can be produced by inkjet printing, the ink of which comprises metal particles. This printing can be carried out directly on the substrate, or in an alternative, on a thin sheet of polyethylene naphthalate (PEN) or of polyethylene terephthalate (PET) which will be subsequently deposited on the substrate by vacuum thermoforming.

The strips can also be produced via a two-step molding of the substrate, or also referred to as “two shot molding”. This is a process of injection molding by using two different resins where only one of the two resins can be metallized. Typically, the resin that can be metallized is ABS and the resin that cannot be metallized is polycarbonate. The substrate is then subjected to a process of electroless plating where butadiene is used to chemically roughen the surface and allow the bonding of a copper primary layer.

Due to the thermoplastic nature of the substrate, the use of conventional soldering methods for the electrical contacts is not suitable. The diodes are therefore mechanically and electrically fixed by applying a polymer-based adhesive loaded with metal elements. This is therefore a so-called “cold” application method, i.e. at a temperature, for example 125° or 150°, which does not damage the substrate. After polymerization of the adhesive, it mechanically and electrically fixes the LED.

The electric strips 14, 16, 18, 20, 22, 24 and 26 can comprise several layers, particularly copper (Cu), nickel (Ni) and/or gold (Au). The presence of a copper layer is advantageous for providing a heat screen function and/or reinforcing the electrical shielding function. The presence of a nickel layer is advantageous for providing a magnetic shielding function. The presence of a gold layer is advantageous for providing an aesthetic or optical function. By way of example, the electric strips can comprise a first copper layer with a thickness between 10 and 20 rim, followed by a nickel layer with a thickness of approximately 4 μm, and followed by a gold layer with a thickness of at least 1 μm.

The auxiliary zones 18 and 20 have an average width of more than 3 mm, preferentially of more than 5 mm.

1. A light module particularly for a motor vehicle, comprising:
substrate;
one or more light sources arranged on said substrate;
set of metal strips arranged on said substrate, said set of metal strips forming at least one power supply zone for said one or more light sources;
some of said set of metal strips extend at a distance from said at least one power supply zone and/or transversely with respect to said at least one power supply zone in such a way as to form one or more auxiliary zones providing an auxiliary function different to a power supply function, for example a heat screen, reflective surface, aesthetic surface, and/or electrical or magnetic shielding function.

2. The module as claimed in claim 1, wherein said one or more auxiliary zones is connected to a supply strip for said one or more light sources, said supply strip being intended to be connected to the ground, said one or more auxiliary zones providing an electrical shielding function.

3. The module as claimed in claim 1, wherein the metal coating of said one or more auxiliary zones comprises nickel, said one or more auxiliary zones providing a magnetic shielding function.

4. The module as claimed in claim 1, wherein said one or more light sources is of the organic light-emitting diode type projecting from said substrate.

5. The module as claimed in, claim 1, wherein said substrate comprises a cavity with a bottom and at least one side wall, said one or more auxiliary zones extending over said at least one side wall, providing a heat screen, a reflective surface and/or an aesthetic surface function.

6. The module as claimed in claim 5, wherein the metal coating of said heat shield, said reflective surface and/or said aesthetic surface comprises copper, gold and/or silver.

7. The module as claimed in claim 5, wherein said cavity is generally elongated in a main direction, several of said one or more light sources being arranged on the bottom of said cavity in said main direction.

8. The module as claimed in claim 7, wherein said one or more light sources on said bottom of said cavity are electrically connected in series by said at least one power supply zone extending in said main direction of said cavity, said one or more auxiliary zones extending from said at least one power supply zone laterally on both sides of said main direction.

9. The module as claimed in claim 2, wherein said substrate comprises at least one front wall projecting from at least one side wall of said cavity, said one or more auxiliary zones being arranged on said at least one front wall.

10. The module as claimed in claim 3, wherein said metal coating comprises nickel, gold, silver and/or copper.

11. The module as claimed in claim 1, wherein said substrate is a rigid molded piece having a three-dimensional shape.

12. The module as claimed in claim 3, wherin said substrate is made from a thermoplastic material doped with metal particles such as to allow the bonding of said metal coating.

13. The module as claimed in claim 1, wherein said one or more light sources is connected to said at least one power supply zone by an adhesive loaded with metal particles, said adhesive being preferentially a polymer adhesive suitable for polymerizing after application.

14. The module as claimed in claim 1, wherein it is suitable for forming at least one light beam along an optical axis towards the front of said module, said one or more auxiliary zones with a metal coating being arranged on a face of said substrate which is directed towards the front of said module.

15. A light device, particularly for a motor vehicle, comprising:
a housing;
at least one light module suitable for forming at least one light beam;
said at least one light module is in accordance with claim 1.

16. The module as claimed in claim 2, wherein the metal coating of said one or more auxiliary zones comprises nickel, said one or more auxiliary zones providing a magnetic shielding function.

17. The module as claimed in claim 2, wherein said one or more light sources is of the organic light-emitting diode type projecting from said substrate.

18. The module as claimed in claim 3, wherein said one or more light sources is of the organic light-emitting diode type projecting from said substrate.

19. The module as claimed in claim 2, wherein said substrate comprises a cavity with a bottom and at least one side wall, said one or more auxiliary zones extending over said at least one side wall, providing a heat screen, a reflective surface and/or an aesthetic surface function.

20. The module as claimed in claim 6, wherein said cavity is generally elongated in a main direction, several of said one or more light sources being arranged on the bottom of said cavity in said main direction.
